(19) United States
(12) Patent Application Publication
(10) Pub. No.: US 2011/0306430 A1
(43) Pub. Date: Dec. 15, 2011

(54) Double Universal Joint Centering Device Having an Outer Race with a Tapered Profile

(75) Inventor: Hans Wormsbaecher, Lake Orion, MI (US)

(73) Assignee: GKN DRIVELINE NORTH AMERICA, INC., Auburn Hills, MI (US)

(21) Appl. No.: 12/815,000

(22) Filed: Jun. 14, 2010

(51) Int. Cl. F16D 3/00

(52) U.S. Cl. 464/118

(57) ABSTRACT

Disclosed is an exemplary constant velocity joint having a first universal joint attached to a first shaft and a second universal joint attached to a second shaft. A centering mechanism pivotally connects the first shaft to the second shaft and is disposed between the first and second universal joints. The centering mechanism includes a ball-shaped member attached to the second shaft and a concave bearing member attached to the first shaft for receiving the ball-shaped member. The bearing member has a conical-shaped inside surface that engages a spherical outside surface of the ball-shaped member.

### BACKGROUND

A double Cardan universal joint is a near-constant velocity universal joint that may be used to correct deficiencies associated with a single Cardan universal joint. A typical double Cardan universal joint generally includes two single Cardan universal joints connected by a unitary coupling yoke having a centering mechanism. Thus, a typical double Cardan universal joint includes a first yoke connected to a first cross shaft, a coupling yoke having a first end connected to the first cross shaft and a second end connected to a second cross shaft, and a second yoke connected to the second cross shaft. The centering mechanism may include mating ball and socket portions provided on the first and second yokes. The coupling yoke cooperates with the centering mechanism to generally bisect an angle between the first and second yokes. As a result, near constant velocity operating characteristics may be attained during operation.

### BRIEF DESCRIPTION OF THE DRAWINGS

FIG. 1 is a partial cross-sectional view of an exemplary double universal joint employing a centering device having an outer race with a tapered profile; and

FIG. 2 is an enlarged view of the centering device employed with the exemplary double universal joint of FIG. 1.

### DETAILED DESCRIPTION

Referring now to the discussion that follows and also to the drawings, illustrative approaches to the disclosed systems and methods are shown in detail. Although the drawings represent some possible approaches, the drawings are not necessarily to scale and certain features may be exaggerated, removed, or partially sectioned to better illustrate and explain the present disclosure. Further, the descriptions set forth herein are not intended to be exhaustive, otherwise limit, or restrict the claims to the precise forms and configurations shown in the drawings and disclosed in the following detailed description.

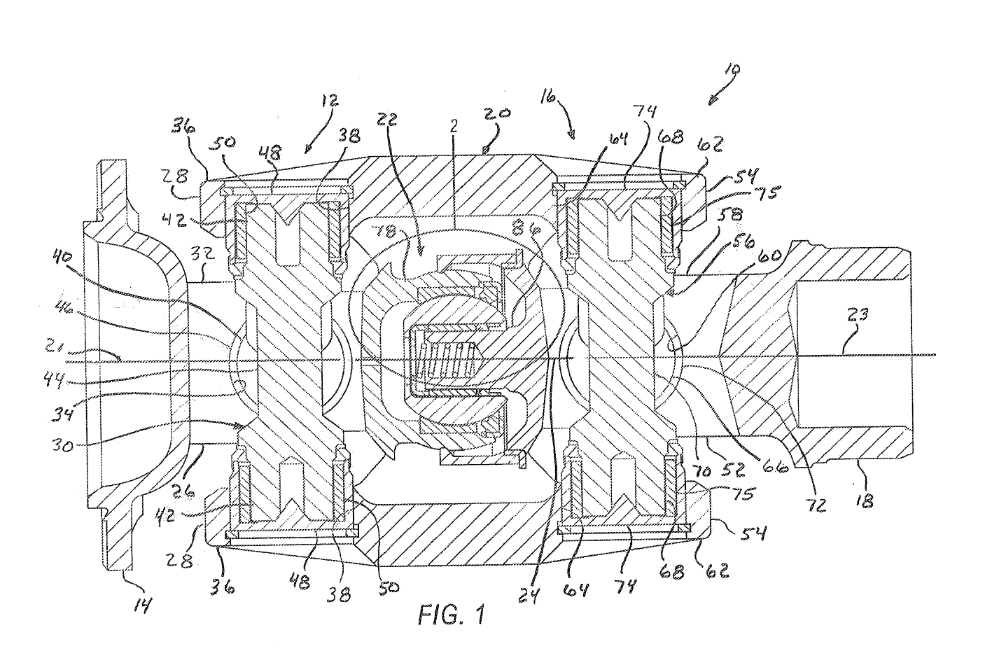

With reference to FIG. 1, a constant velocity joint 10 includes two individual universal joints interconnected by a centering mechanism. The two universal joints each accommodate half an articulation angle when an input shaft is articulated relative to an output shaft to provide generally constant velocity conditions. The two individual universal joints may have substantially the same configuration.

With continued to reference to FIG. 1, constant velocity joint 10 includes a first universal joint 12 connected to a first shaft 14, and a second universal joint 16 connected to a second shaft 18. A universal joint coupling yoke 20 operably connects first universal joint 12 to second universal joint 16. A centering mechanism 22 connects an end of first shaft 14 to an end of second shaft 18. First shaft 14 and second shaft 18 may be arranged in a non-articulated configuration (as shown in FIG. 1), in which a rotary longitudinal axis 21 of first shaft 14 is coaxially aligned with a rotary longitudinal axis 23 of second shaft 18 along a rotary longitudinal axis 24 of constant velocity joint 10. Centering mechanism 22 operates to help ensure that first shaft 14 and second shaft 18 generally assume the same angular position relative to rotary longitudinal axis 24 of constant velocity joint 10 as the two shafts are pivoted relative to centering mechanism 22.

First universal joint 12 may include a first yoke 26 attached to an end of first shaft 14, and a second yoke 28 extending from an end of universal joint coupling yoke 20. A first cross shaft 30 interconnects first yoke 26 to second yoke 28. First yoke 26 is bifurcated and includes a pair of laterally spaced legs 32 arranged generally symmetrical with respect to rotary longitudinal axis 21 of first shaft 14. Only one of the two legs 32 is visible in FIG. 1. Legs 32 include an aperture 34 extending through each leg 32 of first yoke 26. Second yoke 28 is also bifurcated and includes a pair of laterally spaced legs 36 that are arranged generally symmetrical with respect to rotary longitudinal axis 24 of constant velocity joint 10. Legs 36 include an aperture 38 extending through each leg 36 of second yoke 28.

First cross shaft 30 includes a first pair of coaxially aligned trunions 40, and a second pair of coaxially aligned trunions 42. Trunions 40 and 42 extend radially outward from a hub 44 of first cross shaft 30. First trunions 40 are arranged substantially perpendicular to second trunions 42. Only one of the two first trunions 40 is visible in FIG. 1. First trunions 40 are arranged within apertures 34 in legs 32 of first yoke 26, and second trunions 42 are arranged within apertures 38 in legs 36 of second yoke 28.

First universal joint 12 also includes a first pair of bearing caps 46 mounted in apertures 34 of first yoke 26, and a second pair of bearing caps 48 mounted in apertures 38 of second yoke 28. First bearing caps 46 receive and rotatably support first trunions 40 in apertures 34. Similarly, second bearing caps 48 receive and rotatably support second trunions 42 in apertures 38. A roller bearing 50 is arranged between each first bearing cap 46 and first trunion 40, and between each second bearing cap 48 and second trunion 42. Roller bearing 50 associated with bearing cap 46 and first trunion 40 is not visible in FIG. 1, but may have the same general configuration as roller bearing 50 associated with bearing cap 48 and second trunion 42.

Second universal joint 16 may include a third yoke 52 attached to an end of second shaft 18 and a fourth yoke 54 extending from an end of universal joint coupling yoke 20. A second cross shaft 56 interconnects third yoke 52 to fourth yoke 54. Third yoke 52 is bifurcated and includes a pair of laterally spaced legs 58 arranged generally symmetrical with respect to rotary longitudinal axis 23 of second shaft 18. Only one of the two legs 58 is visible in FIG. 1. Legs 58 include an aperture 60 extending through each leg 58 of third yoke 52. Fourth yoke 54 is also bifurcated and includes a pair of laterally spaced legs 62 that are arranged generally symmetrical with respect to rotary longitudinal axis 24 of constant velocity joint 10. Legs 62 include an aperture 64 extending through each leg 62 of fourth yoke 54.

Second cross shaft 56 includes a first pair of coaxially aligned trunions 66 and a second pair of coaxially aligned trunions 68. Trunions 66 and 68 extend radially outward from a hub 70 of second cross shaft 56. First trunions 66 are arranged substantially perpendicular to second trunions 68. Only one of the two first trunions 66 is visible in FIG. 1. First trunions 66 are arranged within apertures 60 in legs 58 of third yoke 52, and second trunions 68 are arranged within apertures 64 in legs 62 of fourth yoke 54.

Second universal joint 16 also includes a first pair of bearing caps 72 mounted in apertures 60 of third yoke 52, and a second pair of bearing caps 74 mounted in apertures 64 of fourth yoke 54. First bearing caps 72 receive and rotatably support first trunions 66 in apertures 60. Similarly, second bearing caps 74 receive and rotatably support second trunions 68 in apertures 64. A roller bearing 75 is arranged between each first bearing cap 72 and first trunion 66, and between each second bearing cap 74 and second trunion 68. Roller bearing 75 associated with bearing cap 72 and first trunion 66 is not visible in FIG. 1, but may have the same general configuration as roller bearing 75 associated with bearing cap 74 and second trunion 68.

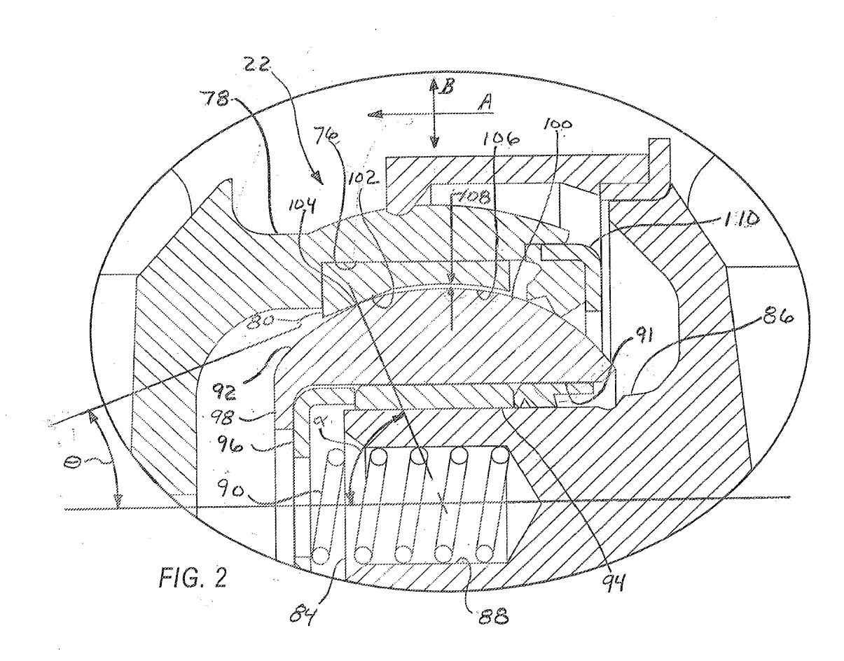

Referring also to FIG. 2, centering mechanism 22 may include a recessed pocket 76 formed in an end 78 of first shaft 14 for receiving a concave bearing member 80. Bearing member 80 is fixedly attached to first shaft 14, such as by press fit, brazing, soldering and welding, to name a few.

Centering mechanism 22 may also include a cylindrical stem 84 that extends from an end 86 of second shaft 18. A counterbore 88 may be formed in the cylindrical stem 84 for receiving a biasing member 90 therein. A spherical ball 92 having the ends thereof truncated includes a bore 91 for receiving cylindrical stem 84. Interposed between ball 92 and cylindrical stem 84 are a plurality of pins 94 for enabling ball 92 to slide and rotate relative to stem 84. A bearing assembly, such as a roller bearing, may be used in place of pins 94. A bushing 96 arranged within bore 91 engages a flange 98 of spherical ball 92.

Biasing member 90 is disposed within counterbore 88 formed in stem 84 of second shaft 18. Biasing member 90 may be a spring or similar biasing device providing a biasing force to direct ball 92 in a biasing direction “A”. In a non-displaced condition of constant velocity joint 10 (as shown in FIG. 1), biasing direction “A” is generally coaxially aligned with rotary longitudinal axis 24 of constant velocity joint 10. Biasing member 90 contacts bushing 96, which in turn engages flange 98 of ball 92. Ball 92 is slidably disposed on stem 84 of second shaft 18, which allows ball 92 to move relative to stem 84 along the displacement path indicated by arrow “A”, and into engagement with bearing member 80. The displacement path indicated by arrow “A” is generally parallel to, and coaxially aligned with a rotary longitudinal axis 23 of second shaft 18.

When first universal joint 12 and second universal joint 16 rotate in response to a deflection load, centering mechanism 22 can displace in a centering displacement path represented by arrow “B”. In a non-displaced condition for constant velocity joint 10, first shaft 14 and second shaft 18 are both aligned coaxially along rotary longitudinal axis 24 of constant velocity joint 10.

Continuing to refer to FIG. 2, ball 92 of centering mechanism 22 includes a spherical outer surface 100 that engages bearing member 80 along a generally conical inside surface region 102. Inside surface region 102 of bearing member 80 may have a generally flat contour, which results in ball 92 contacting bearing member 80 over a relatively narrow circumferential band having a center located along a circumferential contact line 104. This arrangement produces a relatively narrow generally wedge shaped clearance surrounding the contact region between bearing member 80 and ball 92 that helps draw lubricant into the contact region between bearing member 80 and ball 92. Minimizing the contact region between ball 92 and bearing member 80 may help minimize the frictional forces occurring between the two members as constant velocity joint 10 is articulated. This in turn may reduce the amount of heat generated by centering mechanism 22 and prolong the life of the joint. A cone angle Θ of inside surface region 102 may be selected to achieve a desired contact angle α between ball 92 and bearing member 80.

Bearing member 80 may also include a generally spherical-shaped region 106 arranged adjacent conical inside surface region 102. Spherical shaped region 106 may be sized larger than outer surface 100 of ball 92 to provide a gap 108 between outer surface 100 of ball 92 and spherical-shaped region 106 of bearing member 80. Gap 108 may be sized to maximize wicking of lubricant toward contact line 104 between ball 92 and bearing member 80.

Centering mechanism 22 may further include a first seal 110 secured within recessed pocket 76. First seal 110 operates to help prevent leakage of lubricant and prevent foreign matter from entering between ball 92 and bearing member 80. A second seal 112 positioned over cylindrical stem 84 engages bore 91 of spherical ball 92. Second seal 112 operates to help prevent leakage of lubricant and to prevent foreign matter from entering between cylindrical stem 84 and ball 92.

It will be appreciated that the exemplary constant velocity joint described herein has broad applications. The foregoing configuration were chosen and described in order to illustrate principles of the methods and apparatuses as well as some practical applications. The preceding description enables others skilled in the art to utilize methods and apparatuses in various configurations and with various modifications as are suited to the particular use contemplated. In accordance with the provisions of the patent statutes, the principles and modes of operation of the disclosed constant velocity joint have been explained and illustrated in exemplary configurations.

It is intended that the scope of the present methods and apparatuses be defined by the following claims. However, it must be understood that the disclosed exemplary constant velocity joint may be practiced otherwise than is specifically explained and illustrated without departing from its spirit or scope. It should be understood by those skilled in the art that various alternatives to the configuration described herein may be employed in practicing the claims without departing from the spirit and scope as defined in the following claims. The scope of the disclosed constant velocity joint should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future examples. Furthermore, all terms used in the claims are intended to be given their broadest reasonable constructions and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary. It is intended that the following claims define the scope of the device and that the method and apparatus within the scope of these claims and their equivalents be covered thereby. In sum, it should be understood that the device is capable of modification and variation and is limited only by the following claims.

What is claimed is:

1. A constant velocity joint comprising:
a first shaft;
a first universal joint connected to the first shaft;
a second shaft;
a second universal joint connected to the second shaft; and
a centering mechanism pivotally connecting the first shaft to the second shaft, the centering mechanism disposed between the first and second universal joints and including a ball-shaped member attached to the second shaft and a concave bearing member attached to the first shaft for receiving the ball-shaped member, the bearing member having a conical-shaped inside surface that engages a spherical outside surface of the ball-shaped member.
